(19) United States
(12) Patent Application Publication
(10) Pub. No.: US 2007/0095371 A1
(43) Pub. Date: May 3, 2007

(54) Device in the form of a washing machine comprising a bioreactor for cleaning machine parts that are soiled with oil and fat

(75) Inventor: Ulrich Berens, Verl (DE)

Correspondence Address: WHITE, REDWAY & BROWN LLP, 1217 KING STREET, ALEXANDRIA, VA, 22314, US

(73) Assignee: CB Chemie und Biotechnologie GmbH, Gutersloh (DE)

(21) Appl. No.: 10/562,223

(22) PCT Filed: Jun. 3, 2004
(86) PCT No.: PCT/EP04/51016

§ 371 Date: Dec. 23, 2005

(30) Foreign Application Priority Data
Jun. 25, 2003 (EP) 03014221.0

(51) Int. Cl. B08B 3/00; B08B 3/12

(52) U.S. Cl. 134/108; 134/105; 134/198; 134/184

(57) ABSTRACT

The invention relates to a device in the form of a washing machine for cleaning machine parts that are soiled with oil or fat. Said washing machine comprises a housing that can be closed with a lid and that houses a basket for receiving the soiled parts. A spray nozzle system supplied with especially hot cleaning liquid is disposed inside the housing and acts upon the parts to be cleaned that are stored in the basket. For conditioning the cleaning liquid, the device interacts with a bioreactor. The invention is characterized in that the cleaning liquid circulates in a closed circuit between the device and the bioreactor via a discharge line and a supply line. Inside the discharge line means are provided for regulating the temperature of the cleaning liquid for the bioreactor.

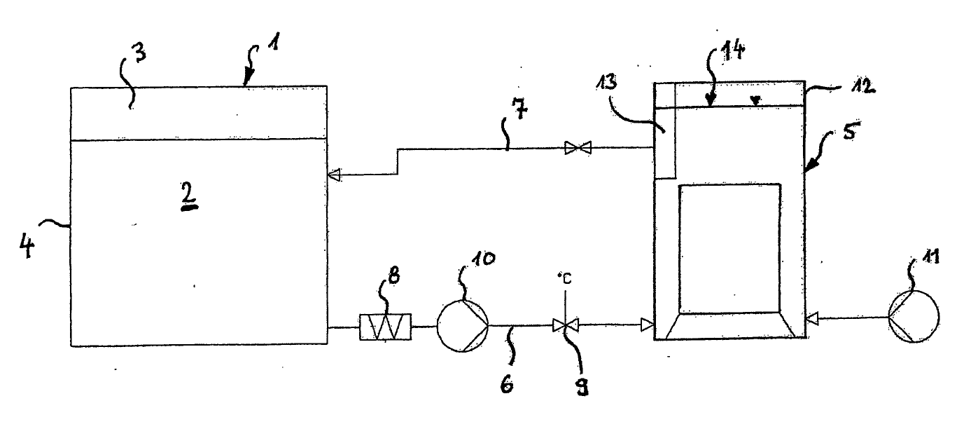

The present invention relates to a device in the form of a washing machine for cleaning machine parts that are soiled with oil or grease, including a housing that can be closed with a lid and which accommodates a basket for receiving the soiled parts, and a spray nozzle system provided in the housing and supplied in particular with hot cleaning fluid which acts upon the parts to be cleaned that are contained in the basket.

Hot water parts machines are known from the related art, which are intended in particular for cleaning machine parts soiled with oil or grease. The hot water parts machine is also capable of removing encrusted oil or grease residues from machine parts. The hot water parts machine has a housing in which, for example, a basket is contained. The machine parts to be cleaned are placed in the basket. Furthermore, a high-pressure system including special nozzles, for example, is accommodated in the housing, which ensures that the parts are thoroughly cleaned and degreased. For example, the basket can rotate in the machine housing so that the parts soiled with oil and grease can be cleaned on all sides. In order to achieve effective cleaning, the high-pressure spray system operates using a cleaning fluid which is heated as high as 70° C.

In the case of this hot water machine known from the related art, there always existed the demand for conditioning the cleaning fluid and, in this case in particular, the contaminated cleaning fluid in order to reintroduce it to the washing process. The cleaning fluid loaded with oil and grease particles during the cleaning process was therefore smoothed by a plate phase separator in which the oil and grease particles in particular again separate from the cleaning fluid so that the oil or grease could be skimmed off in the upper area of the cleaning fluid due to its specific gravity. The purified cleaning fluid was collected and returned to the washing process in the lower area of the plate phase separator. In this type of conditioning of the cleaning fluid in particular, however, the problem occurs that separated oil or fat residues in particular must be disposed of, so that this type of washing device with parts soiled with oil or grease does not represent a closed system.

The object of the present invention is derived from this, to further develop a device in the form of a washing machine for cleaning machine parts soiled by oil or grease in which the cleaning fluid can be operated in a closed system.

According to the present invention, this objective is achieved in that for conditioning the cleaning fluid, the device interacts with a bioreactor, the cleaning fluid being circulated in a closed circuit via a drain line and feed line between the device and the bioreactor and means being provided in the drain line in particular for regulating the temperature of the cleaning fluid for the bioreactor. This embodiment has made it possible for a bioreactor in particular to work with such a known hot water parts washing machine, thus making costly disposal of oil or grease residues unnecessary. The temperature difference between the washing machine and the bioreactor advantageously makes it possible for the cleaning fluid to be operated in a closed-circuit, because the organic contaminants are consumed by the bioreactor in which the bacteria live at a temperature level. To this end, the cleaning fluid preferably heated to 70° C. is cooled to the temperature level preferred for the bacteria of preferably 37° C. using means for temperature regulation in the drain line leading to the bioreactor, thus preventing the death of the bacteria. Correspondingly, the volume flow of cleaning fluid withdrawn from the device is returned to the device via the feed line, thus establishing a closed system that operates without the disposal of oils or greases.

As already mentioned, the bioreactor may preferably be operated in a temperature range of 35 to 40° C., for example, to support the bacteria culture, while the cleaning fluid in the device may preferably be operated at a temperature of 50 to 80° C. Of course, the operating temperature in the device may also be set higher, if it is necessary, for example, to loosen encrusted oil or grease residues from the machine parts, thus resulting in a more effective cleaning of the machine parts contained in the basket.

According to a particularly advantageous refinement of the invention, the hot contaminated cleaning fluid flows through a heat exchanger, which cools the cleaning fluid down to the temperature of the reactor before it flows into the bioreactor via the drain line. The heat exchanger first cools the contaminated cleaning fluid down to a temperature level corresponding to the set reactor temperature. To ensure that, in particular, the temperature level of the reactor also remains constant, a temperature controlled valve is placed in the drain line, preferably between the heat exchanger and the bioreactor, the valve opening only when the bioreactor temperature has been reached, i.e., when it has assumed a temperature range between 36° and 38° C. Accordingly, it is not possible for the bioreactor to be overheated because this is harmful in particular to the bacteria cultures contained in the bioreactor. The bacteria cultures are provided on one level in the reactor, it being possible to arrange the individual bacteria on a fine mesh base so that the contaminated fluid is guided from below through these bacteria adhering to the mesh structures.

In order to control or to accelerate the circuit of the cleaning fluid, a pump circulating the cleaning fluid is provided between the heat exchanger and the valve. According to an enhancement of the bioreactor, which is advantageous in particular, air flows in the bioreactor to support the bacteria. A pump blows this pair into the lower area of the reactor so that the air bubbles ascend through the bacteria situated on the fine mesh.

According to a particularly advantageous enhancement of the bioreactor, a chamber or an overflow to accommodate the conditioned cleaning fluid is situated in the upper area of the bioreactor. The cleaning fluid which is freed from the oil and grease particles by flowing through the bacteria cultures is pressed by additional inflowing contaminated cleaning fluid into an overflow or into an overflow chamber so that the cleaned, conditioned cleaning fluid is contained in it. Connected to the overflow is the feed line, which in turn feeds the spray nozzle system. This results in a continuous, circulating cleaning fluid stream for a hot water parts machine, which operates in particular as a closed system, advantageously without the accumulation of oil or grease residues, the disposal of which is very cost-intensive.

According to a particularly advantageous enhancement of the present invention, a control unit is provided for the device, which controls the pump, the valve and the air supply for the bioreactor. The control unit thus ensures that the pump is activated when the cleaning fluid has reached a specific temperature level, air also being supplied to the bioreactor corresponding to the degree of cleaning or cleaning efficiency of the bioreactor in order to thus obtain an optimally functioning bioreactor culture.

An exemplary embodiment of the present invention will be elucidated in greater detail with reference to the sole FIGURE below.

The sole FIGURE shows a schematic representation of a device 1 in the form of a washing machine 2 for cleaning machine parts soiled with oil or grease, the device essentially including a housing 4 which can be closed with a lid 3. A basket for accommodating the soiled parts, which is not shown in greater detail, is located in housing 4; a spray nozzle system supplied in particular with hot cleaning fluid, also not shown in greater detail, is also situated in housing 4, the spray nozzle system acting on the parts to be cleaned contained in the basket.

For conditioning the cleaning fluid, according to the present invention, device 1 interacts with a bioreactor 5, the cleaning fluid circulating in a closed circuit via a drain line 6 and a feed line 7 between device 1 and bioreactor 5. Means for regulating the temperature of the cleaning fluid are provided in drain line 6 in particular. As can be seen from the depiction, in order to support the bacteria culture which is primarily contained in the lower to center area of bioreactor 5, bioreactor 5 operates in a temperature range from 36° to 38° C. The cleaning fluid in device 1 is preferably heated to a temperature of 70° C. to ensure in particular that encrusted oil and grease residues are separated from the machine parts with the aid of the high-pressure spray nozzle system.

As can be seen from the schematic representation of the sole FIGURE, a drain line 6 is provided in the lower area of washing machine 2, which conveys the contaminated hot cleaning fluid into a heat exchanger 8 which cools the cleaning fluid down to the temperature level of reactor 5 before flowing into bioreactor 5. A preferably temperature-controlled valve 9 is situated in drain line 6 between heat exchanger 8 and bioreactor 5 so that a controlled feed of cleaning fluid brought to the temperature required for bioreactor 5 is provided. This prevents bioreactor 5 from being overheated so that the bacteria cultures are able to live in their supported environment. A pump 10 circulating the cleaning fluid is preferably provided between heat exchanger 8 and valve 9. Pump 10 withdraws the contaminated cleaning fluid from washing machine 2, causing the fluid to flow across heat exchanger 8, and also presses the cooled cleaning fluid through temperature-controlled valve 9 into the lower part of bioreactor 5. As a consequence of the inflow, the contaminated cleaning fluid is guided through the bacteria cultures located in bioreactor 5 so that the oil and grease residues are consumed by them.

In order to support the bacteria culture with respect to its living environment in particular, air flows into bioreactor 5 via a line, the air being drawn in via a pump 11.

In an advantageous enhancement of the invention, a chamber or an overflow 13 is situated in the upper area 12 of bioreactor 5 to accommodate the conditioned cleaning fluid, the fluid level of the conditioned cleaning fluid in bioreactor 5 being denoted by reference symbol 14. It is now obvious that as a consequence of the overflow, the cleaned cleaning fluid flows into the chamber or into overflow 13, to which feed line 7 is connected. Via feed line 7, the cleaning fluid returns to housing 4 of washing machine 2, making it possible to reuse it for the washing operation and thus feed the spray nozzle system again. Device 1 is thus distinguished by the fact that is possible to operate a hot water parts washing machine in a closed system without the accumulation of residues such as oils or greases, the disposal costs of which are very high due to incineration regulations. From an economic perspective, the closed function of this device 1 also shortens the payback period.

According to an enhancement of the present invention, a control unit, which is also not shown in greater detail, may be used for the device, which in particular regulates heat exchanger 8 as well as pump 10, valve 9 and pump 11 for the air feed for bioreactor 5, making it possible to operate the system in an optimum range.

1. A device for purification of machine parts contaminated by oil and grease, comprising:
a purification housing which can be locked with a lid, in which a basket for receiving the contaminated parts is arranged, and in which a spray nozzle system fed by purifying fluid provided in the housing acts upon the parts to be purified which are provided in the basket and a bioreactor for treating the purifying fluid, where the purifying fluid is provided in a closed circuit via a discharge line and a supply line between the purification housing and the bioreactor,
wherein a heat exchanger for cooling the purifying fluid to the temperature level of the rector is located in the discharge line and a valve is located between the heat exchanger and the bioreactor, which valve is opened for the purifying fluid only at the temperature level of the bioreactor.

2. A device as claimed in claim 1, wherein a pump which circulates the purifying fluid is provided between the heat exchanger and the valve.

3. A device as claimed in claim 1, wherein the bioreactor has a temperature range of 35° C. to 40° C. in order to favour the bacteria culture.

4. A device as claimed in claim 1, wherein the purifying fluid in the device has a temperature range of 50° C. to 80° C.

5. A device as claimed in one claim 1, wherein the bioreactor has an air throughput to favour the bacteria.

6. A device as claimed in claim 5, wherein in the upper area of the bioreactor a chamber or an overflow is located in order to receive the treated purifying fluid.

7. A device as claimed in claim 6, wherein the overflow is connected to the supply line which is connected to the spray nozzle system.

8. A device as claimed in claim 1, wherein a control arrangement controls the heat exchanger, the pump, the valve as well as the pump for supplying the air to the bioreactor.

9. A device as claimed in one claim 2, wherein the bioreactor has an air throughput to favour the bacteria.

10. A device as claimed in one claim 3, wherein the bioreactor has an air throughput to favour the bacteria.

11. A device as claimed in one claim 4, wherein the bioreactor has an air throughput to favour the bacteria.

12. A device as claimed in claim 2, wherein a control arrangement controls the heat exchanger, the pump, the valve as well as the pump for supplying the air to the bioreactor.

13. A device as claimed in claim 3, wherein a control arrangement controls the heat exchanger, the pump, the valve as well as the pump for supplying the air to the bioreactor.

14. A device as claimed in claim 4, wherein a control arrangement controls the heat exchanger, the pump, the valve as well as the pump for supplying the air to the bioreactor.

15. A device as claimed in claim 5, wherein a control arrangement controls the heat exchanger, the pump, the valve as well as the pump for supplying the air to the bioreactor.

16. A device as claimed in claim 6, wherein a control arrangement controls the heat exchanger, the pump, the valve as well as the pump for supplying the air to the bioreactor.

17. A device as claimed in claim 7, wherein a control arrangement controls the heat exchanger, the pump, the valve as well as the pump for supplying the air to the bioreactor.
